(19) United States
(12) Patent Application Publication
(10) Pub. No.: US 2003/0002285 A1
(43) Pub. Date: Jan. 2, 2003

(54) Systems of parabolic reflectors and base of a luminaire with fluorescent lamps

(76) Inventor: Antonios Paravantsos, Thessaloniki (GR)

Correspondence Address: THE LAW OFFICE OF CHARLES E. BRUZGA, 11 BROADWAY, STE 400, NEW YORK, NY, 10004, US

(21) Appl. No.: 10/148,794

(22) PCT Filed: Oct. 1, 2001
(86) PCT No.: PCT/GR01/00037

(30) Foreign Application Priority Data
Oct. 26, 2000 (GR) 20000100372

(51) Int. Cl. F21V 7/00

(52) U.S. Cl. 362/346

(57) ABSTRACT

System of reflectors and base of parabolic fluorescent luminary for concentrating and guiding the light, aimed to the improving of its light output and parallel reduction of the construction cost. On the support base (1) of the electrical components of the luminary, the two of the four side walls are made of separate plastic accessories (6), which are assembled by easy and quick snapping on the main body (5) of iron sheet base (1). The plastic side walls (6) of the base (1) have specific cavities and projections (11, 12) in order to maintain a grid of parabolic reflectors (2, 3) which is separable and consists of two separate parts. The one part is the main parabolic components (2) of directing the light, which are placed under the fluorescent lamps (4), while the other is the upper cross-made the luminary independently of the main parabolic components (2). Thus, the main parabolic components (2) do not need to have openings along the lamps (4). As a result, their continuous parabolic shape improves significantly the light output of the parabolic luminary.

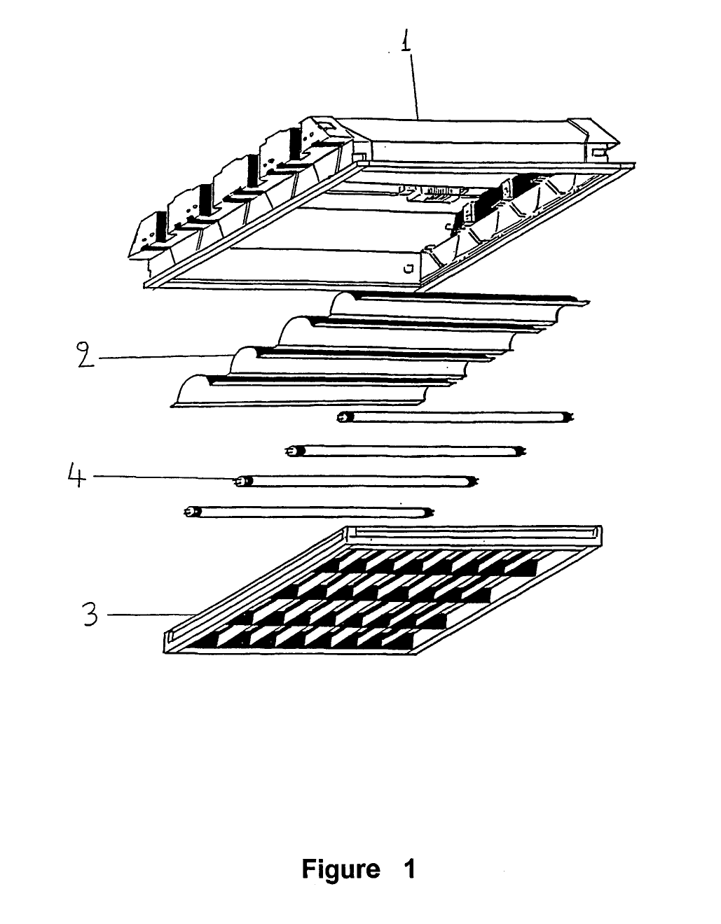

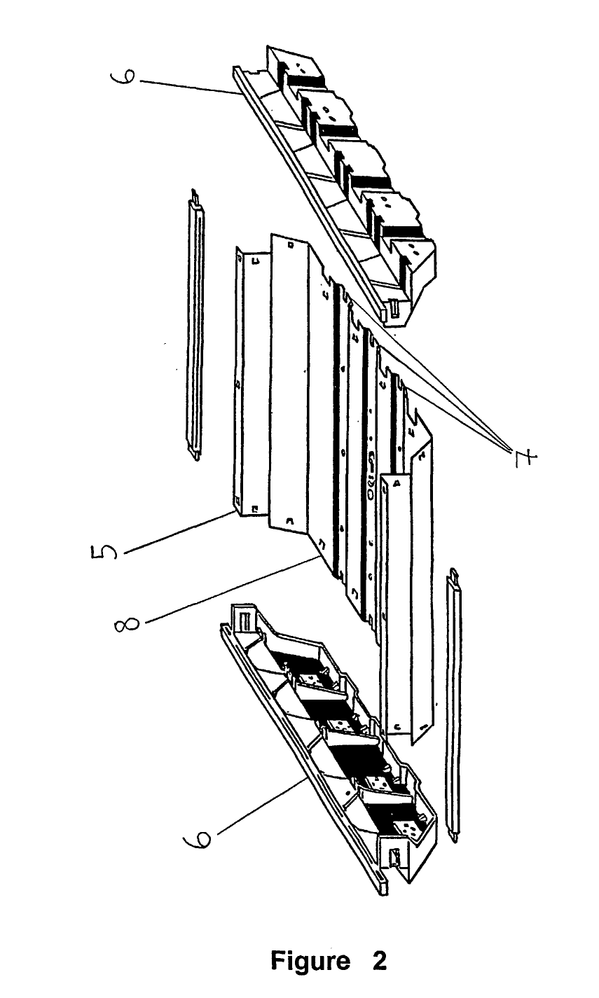

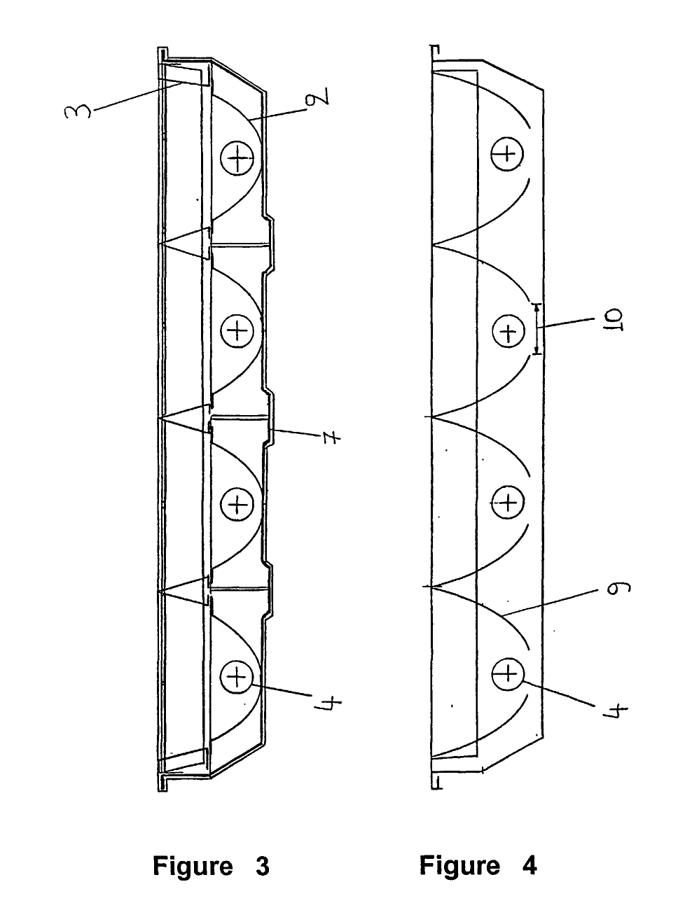

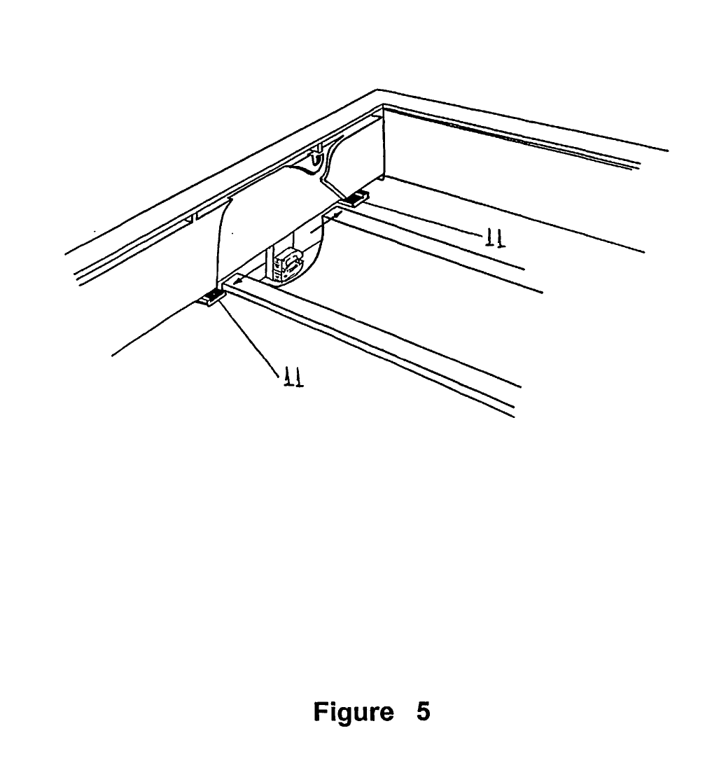

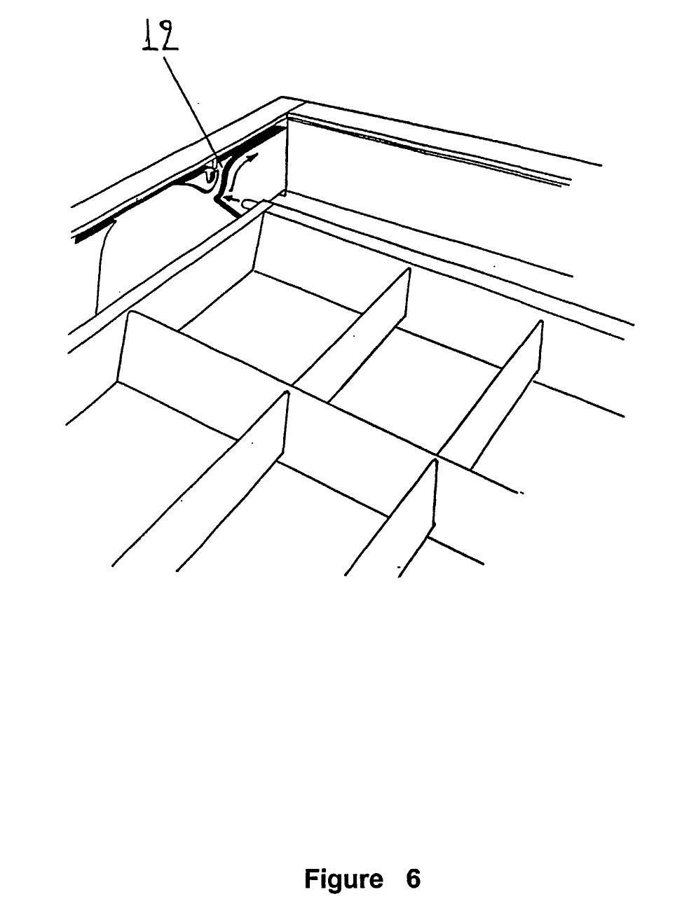

The present invention relates to the system of reflectors and base of parabolic fluorescent luminary bearing parabolic diffusive or catoptrical reflectors, which concentrate and focus the light. This kind of luminary comes in two versions: for recessed mounting into false or exposed ceilings and for surface mounting on solid ceilings. The different models of these luminaries are characterized by the type and the number of the fluorescent lamps they contain.

The recessed luminaries with parabolic louvres, which one finds at the marketplace, are made of a metallic base on which all the necessary electrical components are placed and a grid of parabolic reflectors either diffusive or catoptrical—which concentrate and focus the light: this grid is placed into the metallic base of the luminary. The reflection grid, consisting of parabolic louvres, is made of individual elements of different shape, which are interconnected and thus compose a uniform cellular network. The parabolic louvres, which are deployed in the luminaries for false and solid ceilings and are presently in the international market, are mainly (90%) constructed of a thin aluminium sheet of at least one reflecting surface, either catoptrical or diffusive.

The support base for the electrical components of all the known models of fluorescent luminaries for false ceilings that can be found today is completely made out of iron sheet, which, through the proper cuttings and formations, reaches its final and desirable shape. The shape of the metallic base of the luminaries for false ceilings is a box-like housing of approximately 10 cm depth while it is open on its upper side; the shape of this box, seen from an upper view, is either a perfect square or a rectangular parallelogram of minimum dimensions 10×60 cm and maximum dimensions 62×160 cm. The forming of the iron sheet into boxes of such dimensions and especially the construction of the four sidewalls of the base is achieved by many different shaping phases. This process burdens considerably the production cost of the metallic support base for the electrical components and, consequently, the final price of the parabolic luminary for false ceilings. One of the shaping phases followed by most manufacturers that burdens considerably the time and cost needed for the construction of the base is the welding or the riveted jointing of the side walls of the base at the four side edges of the square or rectangular box so as to achieve steadiness and binding of the box. Furthermore, the sole use of iron sheet for the construction of the base results in making the end product quite weighty. Another consequence of this is the unnecessary weight to be carried by the false ceiling. It is also difficult to handle the product during its production process as well as for the electrician to install it.

The grid of the parabolic reflectors of the fluorescent luminaries for solid and false ceilings is a net of elements of different shapes, which are mainly constructed of thin aluminium sheet, which has at least one catoptrical or diffusive surface. First of all, this grid consists of a square or a rectangular frame, which is formed by four linear elements joined together at the four corners. The main parabolic components, which are to reflect and focus the light, are proportional to the number of lamps of the luminary and are fixed in the two opposite sides and at the inner part of the frame. At the other two sides of the frame and vertically towards the main parabolic components, the elements of the parabolic or non-parabolic transverse blades are placed, thus making it possible to create a reflection grid. This grid, besides concentrating and focusing the light, is also useful in blocking the view of the fluorescent lamps of the installed luminary from an observer, who sees the luminary from a certain angle. The dimension of the angle from which the fluorescent lamps are not visible depends on the quality of the louvres and turns out to be one characteristic feature of recognition which distinguishes the parabolic fluorescent luminaries for exposed and false ceilings from any other and classifies them into different categories.

In all parabolic fluorescent luminaries for solid and false ceilings known until today, in order to replace the lamps or the starters, the louvre made of the cross blades described above has to be removed beforehand so as to gain access to the lamps and the starters. In order that the grid of the reflectors (louvre) could be removed without being blocked by the fluorescent lamps of the luminary, the transverse blades of the grid have openings along its entire length. This means that they are placed exactly underneath the fluorescent lamps so as to overcome the obstacle of the installed lamps upon the removal of the reflection grid. The fact that there is no parabolic reflective surface underneath the fluorescent lamps is the cause that part of the light output which is diffused from the lower part of the lamps, is directed towards the flat surface of the metallic base of the luminary and not spread uniformly, therefore not being concentrated and focused properly towards the floor. This would not have been the case if there were a continuous parabolic reflector underneath the fluorescent lamps. There are sections of the metallic base that are not covered by the reflection grid and these sections serve as light reflection surfaces; as they are visible to the observer, the manufacturers have to paint the whole iron sheet base for the support of the electrical components in white color. This results in an even higher production cost of the luminary in question.

The described invention aims at eliminating the above disadvantages. For the construction of the main base for the electrical components of the parabolic fluorescent luminaries for false ceilings plastic parts are used for the two more elaborated sides of the base. These two plastic sides are assembled to the main body of the iron sheet base by means of simple snapping and not by welding or riveted jointing on the main iron-sheet body of the base. Consequently, the main body of the metallic base is modulated only in its two out of the four side walls of the square or rectangular base of the luminary.

The fact that the main metallic body of the base has not been modulated right from the beginning in the two of its four side walls, allows an easy shaping aiming towards the mechanical reinforcement of the base with three oblong ribs placed at the bottom wall from the one free end to the other. Therefore, this reinforcement enables the reduction of the thickness of the iron sheet used for the construction of the base from 0.6 mm, which is the case with other manufacturers, to 0.4 mm. The flexible quality of the plastic material, from which the two sides of the base are made, facilitates their easy and firm snapping on the main metallic base. On the other hand, the snapping between two metallic pieces would cause some difficulties.

In addition to this, the plastic sidewalls of the base have specifically shaped cavities and projections, which makes it possible that the grid of parabolic reflectors is maintained directly on them without use of any other supplementary details.

The invention improves the light efficiency of the parabolic fluorescent luminary for solid and false ceilings by using a separable reflection grid instead of a unique one. This device allows the main parabolic elements concentrating and focusing the light, to be completely independent from the upper part of the grid. In this way, the main parabolic elements are placed underneath the fluorescent lamps and have an ideal parabolic shape (curved) for maximizing light output. These parabolic elements do not leave openings underneath the lamps. If the lamps or the starters need to be replaced it is only the upper part of the reflection grid that has to be removed. In the lower part, which is independent, the main parabolic elements remain stable in their places without hindering the removal or placing of the fluorescent lamps or the starters of the luminary.

The components of this separable reflection grid are constructed by thermo-mechanical treatment of a special thin plastic film of at least one reflecting surface being either catoptrical or diffusive. This film is by 50% lighter compared to the thinnest aluminium that is used so far in the construction of light reflection grids to this type of luminary.

As a special thin plastic film of at least one reflecting surface is characterized the result of uniting a very thin membrane (approximately 0.015 mm) with surface of high reflective property on a thicker layer of a material with thickness approximately 0.10-0.40 mm, such as PET, the polypropylene, the press—paper, the PVC and others.

The reduction of the thickness of the iron sheet used for the construction of the main body of the base for the electrical components as well as the use of plastic raw material in the two out of the four side walls reduce considerably the total weight of the base of the luminary. This means a weight reduction of 20% up to 35% compared to the bases of other known types of similar luminaries for false ceilings. Thus, the total reduction of the weight of the luminary deriving from the base and the reflection grid, compared to competitive luminaries of the market, reaches 25% to 40%. A positive effect is the lesser loading of the false ceiling with excessive weight and the easier handling of the luminary during the production and the installation process.

The plastic material of the reflection grid eliminates the risk of cut injury of the installer because of sharp edges, as it is the case with aluminium foil. Moreover, the flexibility of the plastic material makes it durable towards damage from mechanical pressure upon installation.

Another advantage is that, thanks to its very low weight, the plastic reflection grid is harmless in case it accidentally falls down from the ceiling.

Finally, the elimination of the openings at the sections of the main parabolic components of the separable grid, which are situated exactly underneath the fluorescent lamps, allows the use of non-painted, galvanized iron sheet, since the iron sheet is completely covered by parabolic reflective surfaces. The use of galvanized iron sheet effaces the additional cost for painting of the base of the luminary and it is more corrosion proof compared to a common black-colored iron sheet.

The benefits offered by this invention are first of all the reduction of the production cost of the supporting base for the electrical components of the parabolic, fluorescent luminaries for false ceilings. This, because of the use of plastic elements that compose the two more elaborated side walls out of the four side walls of the base. The independent plastic side walls are assembled in a very easy manner—snapped on—in the main body of the iron sheet base without the time consuming procedure of welding or riveted jointing which otherwise would have had to be carried out to all four sides of the base, if all of these sides were made out of metal. The plastic sides walls are shaped properly in order to maintain directly the parabolic reflectors of the luminary without use of any other means.

In addition to this, the possibility to strengthen the base by means of special ribs located at the bottom section—thanks to the use of the two additional plastic side walls—allows the reduction of the thickness of the iron sheet by 40% which, eventually, reduces the construction cost of the base (less material, less cost).

The second and most important benefit arriving from this invention is the improvement of the light efficiency of the luminaries for solid and false ceilings. This is achieved by the separable reflection grid, which allows the lower parabolic components, which reflect and direct the light to be independent. In doing so, the upper part of the separable grid serves mainly as a discreet cover of the fluorescent lamps, from a random observer sighting the luminary from a certain angle. Upon replacement of the lamps or the starters, it is necessary to remove only the upper part of the separable reflection grid. Therefore, it is not necessary during this process to remove the main parabolic components for light concentration and focus.

Thus, the main parabolic components are permanently placed underneath the fluorescent lamps and embrace with their ideal (curved) parabolic shape the complete lower part of the lamps without leaving any openings whatsoever, along the lower part of the luminaries as is the case with competitive luminaries where they allow the removal of the unified grid reflectors net, by surpassing the obstacle of installed fluorescent luminaries. The fact that those openings do not exist in the body of the main parabolic components but, on the contrary, there is continuous reflecting surface underneath the fluorescent lamps, leads to the saving of the reflected light so that the light of the luminary is focused and concentrated appropriately towards the desirable direction. The reduction of the thin sheet's thickness, of which is made the main body of the base of the electrical components, the use of two plastic side walls in the base and the use of thin plastic film of at least one reflecting surface for the construction of the reflectors' net result to the great reduction of the weight of the finally produced parabolic false ceiling luminary. This leads to the easier handling of the luminary during the productive procedure and its placement by the installer. Furthermore, the aggravation of false ceilings where those luminaries are based can be avoided.

Drawing 1 is an overall eventual depiction of the parabolic false ceiling fluorescent luminary of the invention with axial transition of the various component parts.

Drawing 2 is an eventual depiction of the electrical components' support base of the parabolic false ceiling luminary of the invention with axial transition of its components.

Drawing 3 is a transversal section of the parabolic luminary of the invention vertical to the axis of fluorescent lamps.

Drawing 4 is a transversal section of a random parabolic false ceiling luminary of the market vertical to the axis of fluorescent lamps.

Drawing 5 is a picture of the specific shaping of the plastic side walls for maintaining the main parabolic components of the separable grid of reflectors.

Drawing 6 is a picture of the specific shaping of the plastic side walls for maintaining the upper section of the separable grid of reflectors.

Here is the description of the invention's application with references to the drawings.

The parabolic fluorescent false ceiling luminary of the invention contains the support base (1) of the electrical components and a divided grid of reflectors (2,3) for the concentration and focalization of the light emitted by the fluorescent lamps (4). The support base (1) of the electrical components consists of the main iron sheet body (5) and of two plastic side walls (6), which are assembled on the main body by sheet (5) snapped in an easy way without the time-consuming procedure of welding or riveted jointing that would be needed on the four corners of the box if all four sides of the base (1) were metallic.

Due to the use of plastic side walls (6) on the base (1), the main iron sheet body (5) of the base is initially free at both sides (8) without having pre-shaped the two of its four side walls. Thus it is possible to rib (7) the bottom of the main base (1) body (5) with the appropriate shaping all along the main sheet body (5) from the one free end to the other. This mechanical support of the bottom of the main base body (5) allows the reduction per 40% of the thickness of the used iron sheet, contributing to reducing the cost of the material's purchase. Furthermore, the construction of two base (1) side walls (6) of plastic raw material as well as the reduction of the sheet's thickness result in the reduction of the base's weight (1) per 20% up to 35% in relation to the respective competitive luminaries.

According to the present invention, the grid of parabolic reflectors (2,3) is divided into two parts. The lower part consists of main parabolic light reflection and direction components (2) which are supported on the two plastic side walls (6) of the base (1) by means of specific cavities and projections (11) in such a position that they are placed permanently behind the fluorescent lamps (4). The upper part is a grid net (3) of components of different form, of the same reflecting surface with the main parabolic components (2), which, on the one hand, helps the main parabolic components (2) to direct the light, while, on the other hand, it is used in order to present a beautiful image with the formation of multiple reflecting levels which, simultaneously, manage to hide the fluorescent lamps (4) from an observer who sees the luminary from a certain optical angle. The upper part (3) of the separable grid of reflectors (2, 3) is maintained directly by the specifically shaped plastic side walls (6) by means of the proper cavities (12).

The dividing of the grid of reflectors in two parts allows the removal of the upper part (3) independently to the firmly placed main parabolic components (2) at the lower part of the luminary. In case it is necessary to replace lamps or starters in the luminary, only the upper part (3) of the divided reflectors' net (2,3) is removed from the luminary, without effecting the main parabolic components (2). Thus, the main parabolic components (2) do not need to leave the known openings (10) all along, which, in other parabolic fluorescent luminaries for exposed and false ceiling are used in order that the unified grid of reflectors (9) overpass the obstacle of fluorescent lamps (4) when it is necessary to remove it from the luminaries for replacing a damaged lamp or starter. Thus. the main parabolic components (2) of the invention are continuous underneath the lamps, without openings and are shaped in the ideal parabolic form which increases enormously the luminary performance due to the appropriate direction of light.

Both parts of the divided grid of reflectors (2,3) of the invention's luminary constitute the composition of elements of various forms, which are manufactured by thermo-mechanical shaping from a thin plastic film of at least one reflecting surface. The low specific gravity of the thin plastic film in relation to the one of the aluminium leads to the reduction by 50% of the total weight of the divided grid of reflectors (2,3). The low weight in combination with the plastic quality of material eliminates the risk of injury of the installer because of sharp edges while the flexibility makes it durable towards damage from mechanical pressure upon installation. For the same aforementioned reasons, it does not provoke accident in case of random fall.

1. System of reflectors and base of parabolic fluorescent luminary consisting of the support base (1) of electrical components and of the grid of parabolic reflectors (2,3) of catoptrical or diffusive surface for the concentration and focalization of light emitted by fluorescent lamps (4). The invention is characterized by the fact that the two more elaborated side walls of the support base (1) of the electrical components, are made of plastic accessories (6), which are assembled by snapping in minimum time, without welding or riveted jointing on the main body (5) of the base iron sheet (1). These plastic side walls (6) of the base (1) have specifically shaped cavities and projections (11, 12) which allow to maintain the parts of a parabolic reflectors grid (2,3) without use of any other supplementary details. The invention is also characterized by the fact that the grid of reflectors (2,3) is separable and consists of two separate parts One part is the main parabolic components (2) of concentrating and directing the light which are placed close to the bottom of the base (1) under the fluorescent lamps (4) which are retained in their places by means of specific cavities—projections (11) on the body of the two plastic side walls (6). The other part is the upper part (3), which is a cross-made grid, placed over the main parabolic components (2) and over the fluorescent lamps (4) and is maintained on its place by means of specific cavities—projections (11, 12) on the plastic side walls (6) of the base (1). This upper part (3) of the separable grid of reflectors (6) can be removed from the luminary when necessary, completely independently, so that there is no need to remove the main parabolic components (2) which stay on their places in the base (1).

2. System of reflectors and base of parabolic fluorescent luminary according to the claim 1 which is characterized by the fact that, due to the divided grid of reflectors (2,3), the main parabolic components do not need to be removed from their positions when lamps or starters need to be replaced in the luminary and that is why there is continuous parabolic form underneath the lamps without the known openings all along, which would certainly exist if the main parabolic components (2) were unified in a unified total on the upper grid (3) and should have been removed from the base of the luminary by surpassing the obstacle of fluorescent lamps (4). The continuous reflecting surface without openings of the main parabolic components (2) underneath the fluorescent lamps (4) results in the saving of light emitted by lamps (4) towards the bottom of the base (1) while all beams are focused and guided appropriately towards the desirable direction, by maximization the light output.

3. System of reflectors and base of parabolic fluorescent luminary according to the claim 1 which is characterized by the fact that, since the two of the four side walls of the main body (5) of the base (1) made from iron sheet, are not shaped, allows the easy shaping of the iron sheet, for mechanical support of the base, with oblong ribs (7) on the bottom of the base (5) from the one until the other free end. This support gives the possibility to reduce the thickness of the used iron sheet and results in the reduction of the material's cost.

4. System of reflectors and base of parabolic fluorescent luminary according to claim 1 which is characterized by the fact that its various components constitute the divided grid of reflectors (2,3), are made of thin plastic film of at least one reflecting surface, either catoptrical or diffusive. The shaping of the components of the divided grid of reflectors (2,3) is achieved automatically and productively with special thermo-mechanical processing of the thin plastic film so that the shaping of even the most difficult curvy intersections of the main parabolic components (2) of the divided grid (2,3) can be achieved.

5. System of reflectors and base of parabolic fluorescent luminary according to claim 1 which is characterized by the fact that, due to the low specific gravity of the plastic film, the weight of the divided grid of reflectors (2,3) is approximately the half of the weight of a grid of reflectors of exactly the same form which would have been made of the thinnest aluminum sheet of catoptrical or diffusive surface to be found on the market.

6. System of reflectors and base of parabolic fluorescent luminary according to claim 1 is characterized by the fact that the plastic property of the divided grid of reflectors (2,3) eliminates the risk of cut injury of the installer because of sharp edges of the luminary while the flexibility of the plastic material makes it durable towards damage from mechanical pressure upon installation or removal.

7. System of reflectors and base of parabolic fluorescent luminary according to claim 1 is characterized by the fact that the reduction of the iron sheet's thickness used for the construction of the main body (5) of the base (1) of electrical components as well as the use of plastic raw materials on both side walls (6) of the base (1), result in the important reduction approximately by 20% up to 30% of the weight (1) of the base of the luminaries in relation to the bases of the other known parabolic fluorescent luminary for false ceiling. This, in combination with the minimum weight of the divided grid of reflectors (2,3) brings an overall reduction of the luminary's weight in relation to the others existing in the market by 25% up to 40% The lower weight of luminary results in the smaller aggravation of the false ceiling with extra weight and the easier handling of the luminary during the productive procedure and its placement by the electrician—installer.

8. System of reflectors and base of parabolic fluorescent luminary according to claim 1 is characterized by the fact that the main body (5) of the base (1) of electrical components, is fully covered by the divided grid of reflectors (2,3) resulting in the avoiding the painting of the iron sheet, since it is not a reflecting surface of light and there are no areas visible by the observer.
